(19) United States
(12) Patent Application Publication
(10) Pub. No.: US 2025/0274809 A1
(43) Pub. Date: Aug. 28, 2025

(54) QUALITY OF SERVICE FLOW MODEL FOR LOW-LATENCY SERVICES

(71) Applicant: GOOGLE LLC, Mountain View, CA (US)

(72) Inventor: Ching-yu Liao, Mountain View, CA (US)

(21) Appl. No.: 19/127,347

(22) PCT Filed: Nov. 6, 2023
(86) PCT No.: PCT/US2023/078869

§ 371 Date: May 5, 2025

Related U.S. Application Data
(60) Provisional application No. 63/480,096, filed on Jan. 16, 2023.
(60) Provisional application No. 63/382,450, filed on Nov. 4, 2022.

(51) Int. Cl. H04W 28/02; H04W 4/24

(52) U.S. Cl. CPC H04W 28/0268; H04W 28/0263; H04W 4/24

(57) ABSTRACT

An entity in a core network (CN) of a wireless communication system receives quality-of-service (QoS) parameters related to protocol data unit (PDU) set based handling of traffic (1602); performs, using the QoS parameters, QoS binding of a service data flow to a QoS flow for a certain media type (1604); generates a QoS profile associated with a QoS flow identifier (QFI) of the QoS flow, and transmits the QoS profile to a radio access network (RAN) via which the UE accesses the CN (1606).

### CROSS-REFERENCE TO RELATED APPLICATIONS

This application claims priority to and the benefit of the filing date of provisional U.S. Patent Application No. 63/382,450 entitled “Framework of QoS Flow Model for XR and Media Services,” filed on Nov. 4, 2022 and provisional U.S. Patent Application No. 63/480,096 entitled “Framework of QoS Flow Model for XR and Media Services,” filed on Jan. 16, 2023. The entire contents of the provisional applications are hereby expressly incorporated herein by reference

### FIELD OF THE DISCLOSURE

This disclosure relates generally to wireless communications and, more particularly, to supporting traffic organized into packet data unit (PDU) sets.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Base stations that operate according to fifth-generation (5G) New Radio (NR) requirements support significantly larger bandwidth than fourth-generation (4G) base stations. In some cases, a base station can transmit to a user device, or a user equipment (UE), data associated with extended Reality (XR), which refers to such technologies as Augmented Reality (AR), Virtual Reality (VR), Mixed Reality (MR), and cloud gaming. The technologies generally involve quasi-periodic streaming and are associated with high data rates and low-latency requirements.

The 3rd Generation Partnership Project recently proposed to study support of XR and media (XRM) to provide 5G system (5GS) support of advanced media services, e.g. High Data Rate Low Latency (HDRLL) services, AR/VR/XR services, and tactile/multi-modality communication services. More specifically, the objectives include enhancements of network exposure to support interaction between 5GS and XRM applications, and enhancements of quality-of-service (QoS) and policy for XR services and media service transmissions.

When supporting XR communications (or, more generally, a data-intensive service), an application executing on a user equipment (UE) can receive or originate a data burst, which can be understood as multiple units (PDUs) communicated within a relatively short period of time. A data burst can include or more PDU Sets. A PDU Set in general includes one or more PDUs carrying the payload of one unit of information generated at the application level (e.g. frame(s) or video slice(s) etc. for XR Services). The PDUs in a PDU Set also correspond to a certain QoS flow.

To support XRM services for PDU-set-based handling in a 5GS, a radio access network (RAN) such as the next generation RAN (NG-RAN) must be aware of XRM services the 5G core network (CN) provides. The RAN receives, from the Session Management Function (SFM) via an Access & Mobility Management Function (AMF) and over the N2 interface, PDU Set QoS parameters in the QoS profile. The RAN further receives, from a User Plane Function (UPF) via the N3 interface, PDU Set information received for the downlink XRM traffic or, from the UE over Uu interface, PDU Set information for the uplink XRM traffic. The RAN must perform PDU Set based QoS handling for radio resource scheduling using the received PDU Set QoS Parameters and the PDU Set Information included in a PDU received over user plane N3 interface from UPF. More specifically, the PDU Set Information can reside in the General Packet Radio Service (GPRS) Tunnelling Protocol (GTP)-U header information of the PDU.

Currently, a 5G CN provides one QoS profile including QoS parameters and QoS flow ID (QFI) to the RAN during PDU Session establishment/modification procedures. Based on the QoS profiles of multiple QoS flows, the RAN can determine and perform a mapping of one or more QoS flows to a DRB. The RAN thus can provide some flexibility to radio resource management by multiplexing multiple QoS flows that have similar QoS requirements to one DRB.

The existing techniques are based on certain assumptions about QoS flows, types of PDU Sets, DRB, and QoS parameters (see FIGS. 6A-D discussed below), which may not always result in efficient handling of traffic.

The existing QoS model in a 5GS operates between a UE and a PSA (PDU Session Anchor) UPF. A 5GS including a 5G CM, a RAN, and a UE can support PDUs on a per-PDU-Set basis by considering the application traffic information in the Real-time Transport Protocol (RTP)/Secure RTP (SRTP) extension header. To enable QoS handling on a per-PDU-Set basis, a PDU-Set-based QoS model would need to address at least the following issues.

For a PDU-Set-based QoS flow, it is not clear what granularities of the QoS parameters are needed for the PDU Set based QoS flows that belong to the same media stream. RAN currently cannot schedule radio resources and handle PDU Set based QoS flows in terms of aggregated QoS flows and on a per-QoS-flow basis.

Further, it is not clear what information the application server (AS) can provide to the 5G CN via a user plane and/or via control plane signaling. On the one hand, the application layer information may not directly map to the QoS characteristics of a PDU in the transport layer and the radio resource unit in the radio network layer. On the other hand, application implementation would vary in some configurable settings between the AS and an application client on the UE even for the same media code. There is no framework for providing additional information if more advanced media codecs become available and applicable to PDU Set handling in a 5GS.

Still further, it is not clear how a 5G CN should bind a service data flow, e.g., a service data flow corresponding to an IP 5 tuple flow, to one or more QoS flows, and/or more granular sub-QoS flows based on the PDU Set information from the AS.

Moreover, is not clear what information in a QoS profile the 5G CN can provide to the RAN over the N2 interface.

Also, it remains unclear what PDU Set information a UPF can apply or delivered to the RAN, and how the RAN can enforce QoS parameters of one or more QoS flows that belong to the same or different IP flows, for scheduling a data radio bearer (DRB) on a per-PDU-Set basis.

### SUMMARY

An example embodiment of the techniques of this disclosure is a method in a core network (CN) of a wireless communication system, the method comprising: receiving quality-of-service (QoS) parameters related to protocol data unit (PDU) set based handling of traffic; performing, using the QoS parameters, a QoS binding of a service data flow (SDF) to at least one QoS flow for a certain media type; generating a QoS profile associated with a QoS flow identifier (QFI) of the QoS flow for the media type; and transmitting the QoS profile to a radio access network (RAN) via which the UE accesses the CN.

Another example embodiment of these techniques is a device comprising processing hardware and configured to implement the method above.

### BRIEF DESCRIPTION OF THE DRAWINGS

FIG. 1 is a block diagram of an example wireless communication system, such as 5GS, that supports PDU set handling in the uplink direction using the techniques of this disclosure;

FIG. 2 is a block diagram of an example protocol stack according to which the UE of FIG. 1 can communicate with the RAN of FIG. 1;

FIG. 3 is a service-based representation of the 5GS architecture, including the overall non-roaming reference architecture of the policy and charging control framework for the 5GS;

FIG. 4 is a reference-point based representation of the 5GS architecture, including overall non-roaming reference architecture of the policy and charging control framework for the 5GS;

FIG. 5 is a high-level messaging diagram of an example scenario in which a UE uses XRM services using PDU set handling;

FIG. 6A illustrates an existing one-to-one mapping between PDU sets and QoS flows in the non-access stratum (NAS), and one-to-one mapping between QoS flows and data radio bearers (DRBs) at an application server (AS);

FIG. 6B illustrates an existing one-to-one mapping between PDU sets and QoS flows in the NAS, and possible multiplexing of QoS flows at the AS;

FIG. 6C illustrates an existing possible multiplexing of PDU sets in one QoS flow in the NAS, and one-to-one mapping between QoS flows and DRBs at the AS;

FIG. 6D illustrates an existing possible multiplexing of PDU sets in one QoS flow in the NAS, and demultiplexing of types of PDU sets from a QoS flow to multiple DRBs at the AS;

FIG. 7 illustrates a QoS model in which traffic of one particular media type corresponds to a certain IP flow;

FIG. 8 is a messaging diagram of an example scenario of QoS provisioning using the QoS model of FIG. 7, for example;

FIG. 9 illustrates a QoS model according to which the application layer uses different IP flows for different PDU set types of a media stream;

FIG. 10 illustrates a QoS model according to which the application layer uses the same IP flow for different PDU Set types of a media stream, and the SMF binds one SDF to multiple QoS flows for different PDU Set types;

FIG. 11A illustrates a QoS model according to which the application layer the same IP flow for different PDU Set types of a media stream, and the SMF binds one SDF to one QoS flow with multiple Sub-QoS flows for different PDU Set types

FIG. 11B illustrates a QoS model similar to that of FIG. 11A, but with the UPF identifying each Sub-QoS flow based on the detected packet header information;

FIG. 12 is a flow diagram of an example method for generating PDU set configuration at an AS or an AF;

FIG. 13 is a flow diagram of an example method for processing a PS-importance configuration policy at an SMF;

FIG. 14 is a flow diagram of an example method for generating an N4 message for a UPF, which can be implemented in an SMF;

FIG. 15 is a flow diagram of an example method for providing QoS rules to a UE, which also can be implemented in an SMF; and

FIG. 16 is a flow diagram of an example method for supporting PDU Set based QoS flows, which can be implemented in an SMF.

### DETAILED DESCRIPTION OF THE DRAWINGS

The devices and logical entities discussed below improve the existing end-to-end QoS flow model so as to efficiently adapt to XRM services based on PDU Set QoS Parameters and PDU Set identification information.

More particularly, the solutions discussed below include a reference QoS model for QoS provisioning between a UE and a PSA UPF. According to one implementation of the reference QoS model, traffic of one particular media type, with certain QoS requirement, corresponds to an IP flow. According to another implementation of the reference QoS model, the application layer uses different IP flows for different PDU Set types, e.g., I/P/B frames of a video stream or slices, of a media stream. According to yet another implementation of the reference QoS model, the application layer uses the same IP flow for different PDU Set types, e.g., I/P/B frames or slices, of a media stream, and a Session Management Function (SMF) binds one service data flow (SDF) to multiple QoS flows for different PDU Set types. In still another implementation, the application layer uses the same IP flow for different PDU Set types, e.g., I/P/B frames or slice) of a media stream, and the SMF binds one SDF to one QoS flow with multiple Sub-QoS flows for different PDU Set types.

In some implementations, network nodes can characterize each Sub-QoS flow by PDU Set type, PDU Set Importance level, or both, based on the UPF-detected information from a higher layer of the packet header. For example, for an RTP/SRTP-based media stream, the characterization can be based on bits included in the existing RTP/SRTP extension header or a new extension header; for a slice-based media stream, the characterization can be based on NAL bits in network abstraction layer header.

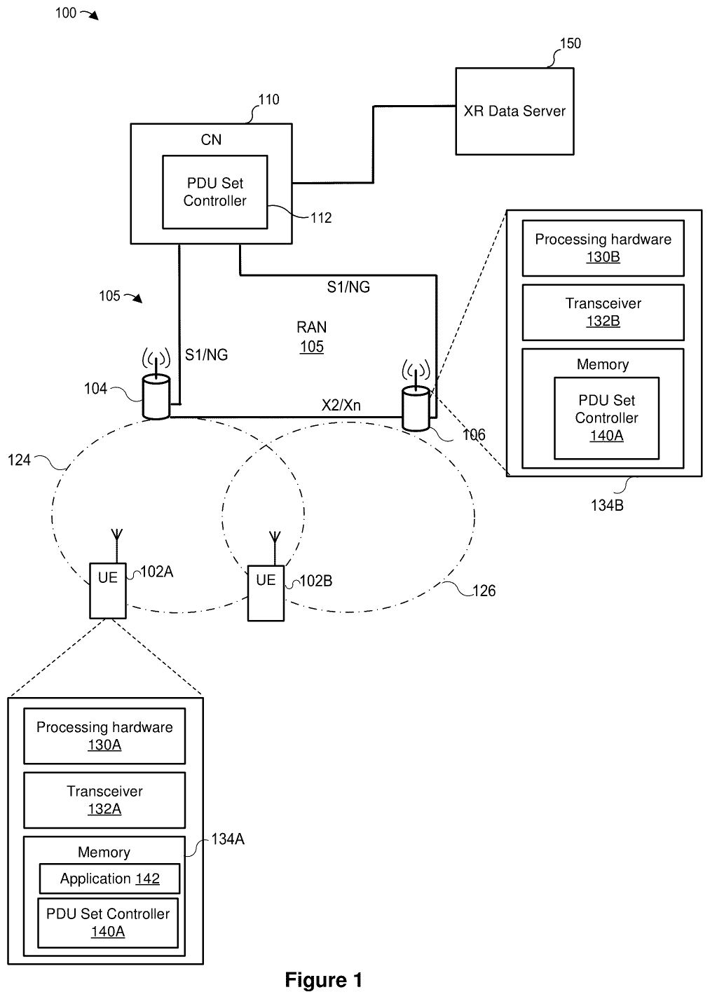

Referring first to FIG. 1, an example wireless communication system 100 can implement one or more of the techniques of this disclosure for supporting PDU-set-based handling of traffic, particularly the uplink traffic from a UE. The example wireless communication system 100 includes UEs 102A and 102B, a base station (BS) 104, a base station 106, and a core network (CN) 110, such as a fifth generation (5G) core (5GC). The base stations 104 and 106 can operate in a RAN 105 connected to the CN 110. The CN 110 can also be implemented as a sixth generation (6G) core or another suitable core network.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. The cells 124 and 126 can partially overlap, so that the UE 102A or 102B can select, reselect or hands over from one of the cells 124 and 126 to the other. In general, the RAN 105 can include any number of base stations, and each of the base stations can cover one, two, three, or any other suitable number of cells. The UE 102 can support at least a 5G NR (or simply, “NR”) air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

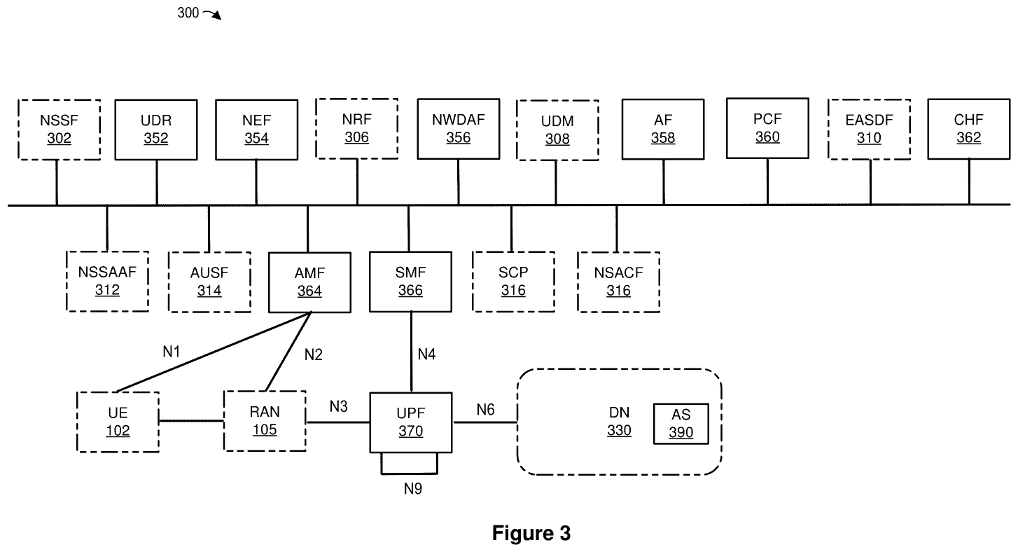

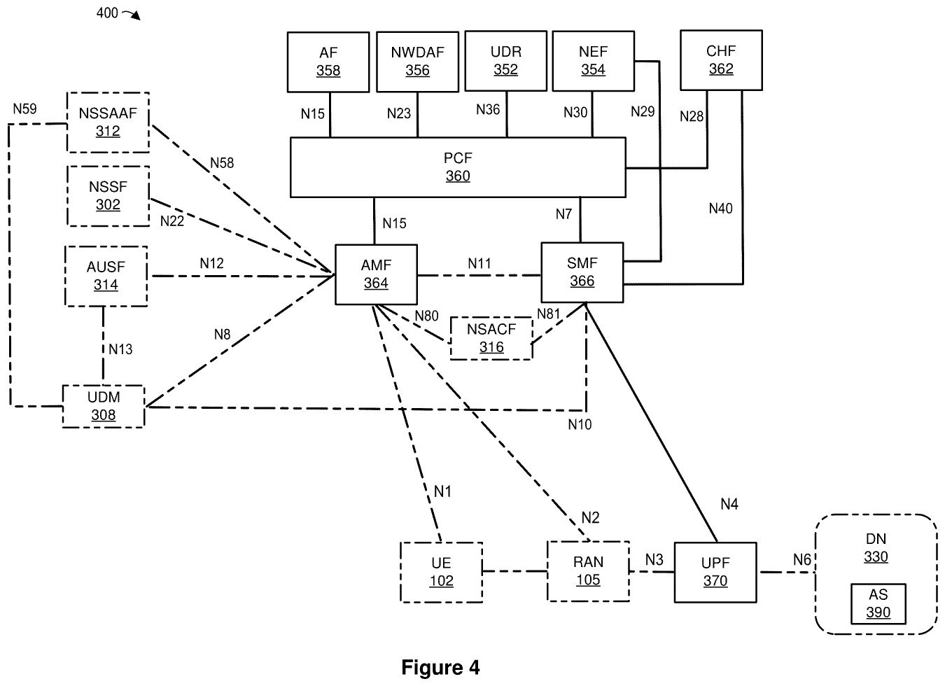

Several NFs that make up the CN 110 are discussed below with reference to FIGS. 3 and 4. One or more of the NFs of the CN 110 implement the PDU set c3ontroller 112 which determines how and when to provide information related to uplink PDU-set-based handling to the UEs 102A and 102B.

While not shown in FIG. 1 to avoid clutter, the CN 110 may include processing hardware, which may include one or more general-purpose processors (e.g., CPUs) and a non-transitory computer-readable memory storing instructions that the one or more general-purpose processors execute. Additionally or alternatively, the processing hardware can include special-purpose processing units. The processing hardware may be configured to implement the techniques of this disclosure for enabling 5GS support of advanced media services.

The base station 104 is equipped with processing hardware that can include one or more general-purpose processors (e.g., CPUs) and a non-transitory computer-readable memory storing instructions that the one or more general-purpose processors execute (not shown). Additionally or alternatively, the processing hardware can include special-purpose processing units.

The UE 102A is equipped with processing hardware 130A that can include one or more general-purpose processors such as CPUs and non-transitory computer-readable memory storing machine-readable instructions executable on the one or more general-purpose processors, and/or special-purpose processing units. The UE 102A also includes a transceiver 132A to communicate with the RAN 105 over a radio interface. Further, the UE 102A includes a memory 134A storing a PDU set controller 140A. An example application 142 can use the PDU set controller 140A to operate on PDU sets. For example, the application 142 can set an RTP header to utilize PDU Set based processing. The UE 102B can have a similar implementation.

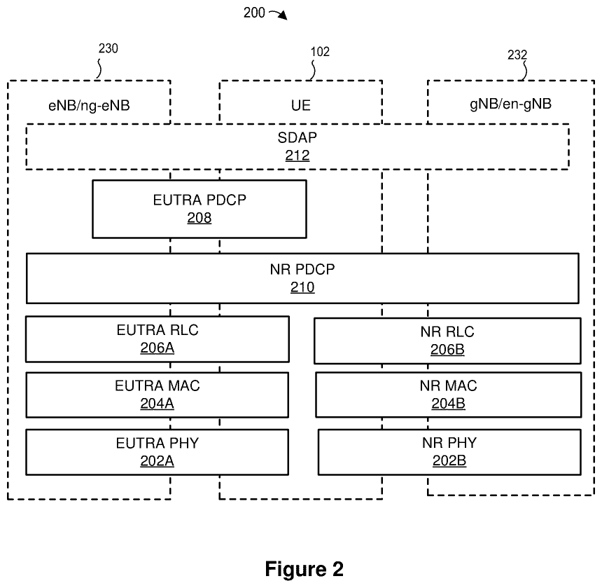

FIG. 2 illustrates, in a simplified manner, an example protocol stack 200 according to which the UE 102 can communicate with an eNB/ng-eNB or a gNB (e.g., one or more of the base stations 104, 106). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 3 is a service-based representation 300 of the 5GS architecture, which the system of FIG. 1 can implement. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSAAF) 312, an Authentication Server Function (AUSF) 314, a Service Communication Proxy (SCP) 316, and a Network Slice Admission Control Function (NSACF) 316. The non-PCC architecture further includes the UE 102, the RAN 105, and a data network (DN) 330. An application server (AS) 390 can operate in the DN 330.

The PCC framework in the architecture 300 includes a Unified Data Repository (UDR) 352, a Network Exposure Function (NEF) 354, a network data analytics function (NWDAF) 356, an Application Function (AF) 357, a Policy Control Function (PCF) 360, a Charging Function (CHF) 362, an Access & Mobility Management Function (AMF) 364, a Session Management Function (SMF) 366, and a User Plane Function (UPF) 370.

When the UPF 370 operates as a PDU Session Anchor (PSA) UPF, to support PDU Set based QoS handling for XRM services, the PSA UPF 370 identifies PDUs that belong to PDU Sets and determines the following PDU Set Information, based for example on the RTP extension header defined in 3GPP TS26.522, which the PSA UPF 370 transmits to the NG-RAN 105 in the GTP-U header. The NG-RAN 105 can use the PDU Set information for PDU Set based QoS handling (e.g., as described in 3GPP TS23.501, for example). The PDU Set Information can include (i) a PDU Set Sequence Number, (ii) an Indication of End PDU of the PDU Set, (iii) a PDU Sequence Number within a PDU Set, (iv) PDU Set Size in bytes, (v) a PDU Set Importance, which identifies the relative importance of a PDU Set compared to other PDU Sets within a QoS Flow. The NG-RAN may use the Priority Level across QoS Flows and PDU Set Importance within a QoS Flow for PDU Set level packet discarding in presence of congestion.

FIG. 4 is a reference-point based representation 400 of the 5GS architecture. In FIG. 4, the non-roaming reference architecture of the PCC framework for the 5GS is illustrated as blocks and connections with solid lines, and components and connections outside the PCC framework are illustrated using dashed lines.

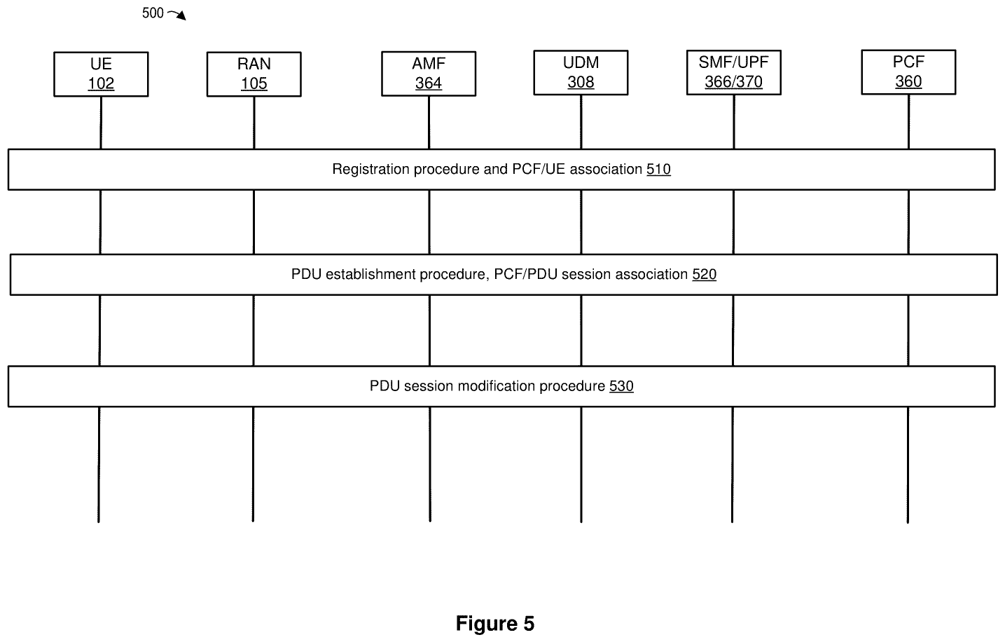

Referring to a scenario 500 of FIG. 5, during a registration procedure 510, the AMF determines whether the UE 102 is authorized to use XRM services based on the XRM Service Capability of the UE and the XRM Service Authorization included in the subscription data received from UDM. After successful registration 510, the UE requests 520 for PDU Session Establishment procedure, and the NG-RAN capable of XRM services can perform PDU Set handling for the QoS flows in a PDU Session based on the XRM service authorization and information received from the SMF via N2 message and GTP-U header via N3 interface from the UPF. The UE or network initiate 530 PDU Session Modification Procedure for the existing PDU Session.

The SMF determines a QoS Profile for the QoS Flow, which is based on received Policy Control and Charging (PCC) rules or pre-configuration. The PSA UPF performs the following: (i) identifies PDUs that belong to PDU Sets based on Protocol Description based on received Packet Detection Rule (PDR), (ii) marks the GTP-U header for PDU Set information as described in TS23.501 clause 5.37.5.2, (iii) and performs PDU-set-based parameters based on received QoS Enforcement Rule (QER).

The network instructs UE with Uplink PDU-set-based Handling information to perform PDU-set-based handling including PDU Set Identification and marking on the uplink media service data flow received from upper layer to provide NG-RAN in band uplink PDU Set information.

According to one implementation, the RAN 105 performs PDU-set-based QoS handling for radio resources management based on the following information: (i) uplink PDU Set information received from the UE over air interface, and (ii) QoS profile containing uplink PDU-set-based QoS parameters.

The Uplink PDU Set Information can include one or more of: (i) a PDU Set Sequence Number, (ii) an Indication of End PDU of the PDU Set, (iii) PDU Sequence Number within a PDU Set, (iv) PDU Set Size in bytes, and (v) PDU Set Importance, which identifies the relative importance of a PDU Set compared to other PDU Sets within a QoS Flow.

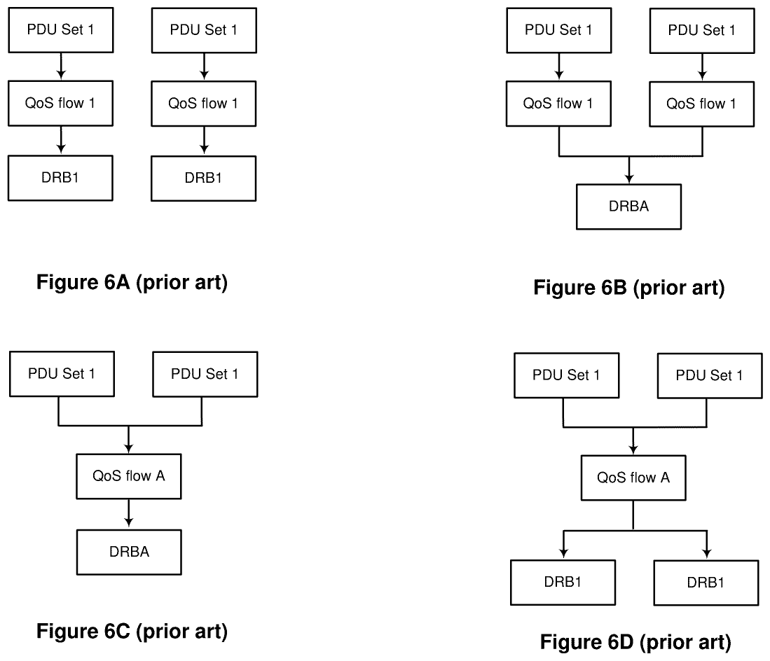

Next, several example types of mapping of PDUs onto QoS flows are considered with reference to FIGS. 6A-D. These models correspond to different combinations of one-to-one mapping and multiplexing/demultiplexing between PDU Sets, QoS flows, and DRBs.

Generally speaking, the QoS models of FIGS. 6A-D assume that different QoS parameters can correspond to a QoS flow. However, for a PDU Set based QoS flow, it is still unclear what granularities of the QoS parameters are needed for the PDU Set based QoS flows that belong to the same media stream. According to the model of FIG. 6A for example, the RAN cannot schedule radio resources and handle PDU Set based QoS flows in terms of aggregated QoS flows or on per-QoS-flow basis.

According to the example model of FIG. 6B, the RAN 105 requires an enhancement to multiplex different QoS flows with different PDU Set QoS requirements, and map these to one DRB based on the following assumptions: the CN 110 binds different types of PDU Sets to different QoS flows, and one QoS profile includes multiple set of QoS parameters for multiple QoS flows. Here, specific solutions are required for the RAN 105 to determine whether to map multiple QoS flows to the same DRB or different DRB based on PDU Set based QoS requirements.

According to the example model of FIG. 6C, the RAN 105 requires a mechanism to demultiplex different sub-QoS flows in a QoS flow and map the sub-QoS flows onto different DRBs based on the following assumptions: the CN 110 binds different types of PDU Sets to different sub-QoS flows, and one QoS profile includes multiple sets of QoS parameters for multiple sub-QoS flows. Solutions are required to allow the RAN 105 to determine whether to map sub-QoS flows to the same DRB or different DRBs based on PDU Set based QoS requirements

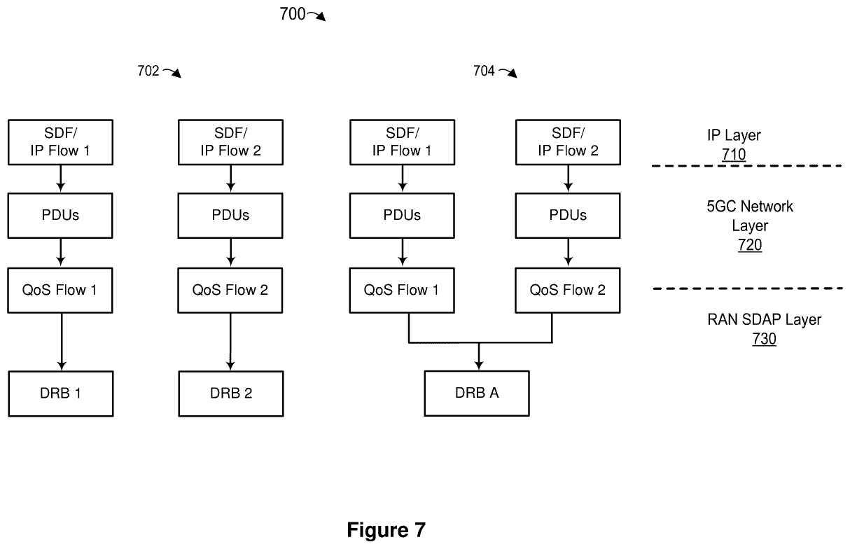

Next, several techniques for enhancing the existing end-to-end QoS flow model for adapting to XRM services based on the PDU Set QoS Parameters and PDU Set identification information are discussed with reference to FIGS. 7-12.

At least some of the techniques discussed below rely on one or more of the following assumptions: an IP flow represents IP 5 tuples, and an SDF includes packet filters that define the application traffic for mapping to a QoS flow; a QoS flow is identified by a QFI; a sub-QoS flow is identified by a sub-QoS flow ID (XQFI), such that one QoS flow contains one or more Sub-QoS flows; one or more QoS flows can be associated with one PDU Session; the PDU Session Resource Setup Request can be implemented as the N2 PDU Session Request message defined in TS23.502, clauses 4.3.2 and 4.3.3.

Referring to FIG. 7, a reference QoS model 700 illustrates example QoS provisioning between a UE such as the UE 102 and a PSA UPF such as the UPF 370.

Using the QoS model 700, an application (e.g., the application 142) requests QoS requirements on a per-PDU basis for a certain SDF (IP flow traffic) of one media type, e.g., video, voice, or XR. The SMF 366 can perform the QoS binding of the SDF from one IP flow to one QoS flow per media type and the can transmit the corresponding QoS profiles to the RAN 105. Each QoS profile can be associated with one QFI and QoS parameters for one media type. The UPF 270 can mark the GTP-U header of each PDU with the corresponding QFI, and the RAN 105 can performs radio resource scheduling and mapping of one or multiple QoS flows to one DRB. In other words, the RAN 105 can implement a one-to-one mapping.

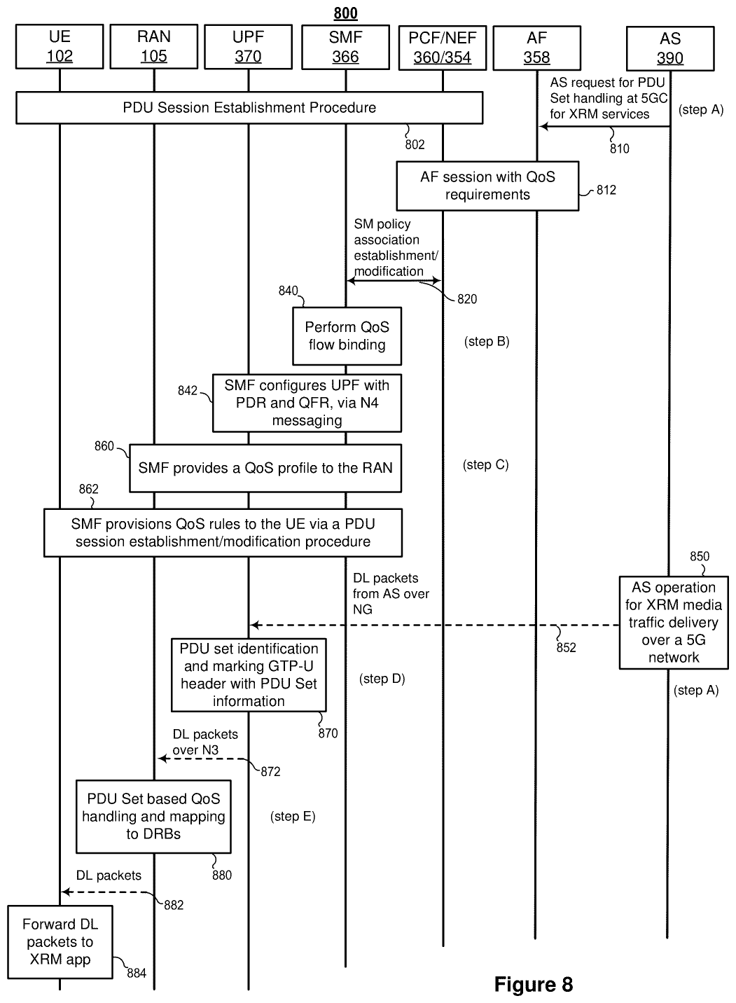

Generally speaking, the communication system 100 can implement the following sequence high-level procedures or steps (discussed in more detail with reference to FIG. 8 below) to support traffic using the QoS model 700: (i) at step A associated with the IP layer 710, the application (e.g., the application 142) requests different QoS requirements from the CN 110 for each IP flow traffic of one media type, e.g., video, voice, XR; at Step B associated with a 5GC layer 720, the SMF 366 performs QoS binding from an IP flow to the QoS flow identified by QFI; at Step C associated with the 5GC layer 720, the UPF 370 marks GTP-U header of each PDU with the QFI; at Step D associated with the 5GC layer 720, the SMF 366 transmits QoS profile to RAN 105, where the QoS profile indicates QFI and the QoS parameters; and at Step E associated with the RAN SDAP layer 730, the RAN 105 performs the mapping between QoS flows and DRBs.

In particular, with continued reference to FIG. 7, the RAN 105 can perform the mapping from QoS flow 1 to DRB 1 and QoS flow 2 to DRB 2 per the corresponding QFI according to a scenario 702, or perform the mapping from QoS flow 1 and from a QoS flow 2 to DRB A according to a scenario 704.

FIG. 8 is a messaging diagram of an example scenario 800 in which events 802, 810, 812, 820, 850, and 852 generally correspond to step A discussed above with reference to the QoS models of FIGS. 7 and 9-12; events 840, 842 generally corresponds to step B, events 860, 862 generally corresponds to step C; events 870, 872 generally correspond to step D; and events 882-884 correspond to step E.

At the beginning of the scenario 800, the UE 102, the SMF 366, and the UPF 370 perform 802 a PDU Session Establishment (e.g., according to clause 4.3.2.2.1 of TS 23.502) or PDU Session Modification, e.g., (e.g., according to clause 4.3.3 of TS 23.502).

The AS 390 transmits 810 a request to enable PDU Set Handling at a 5G network for XRM services. The AF 358 then transmits 812 the information to the PCF 360 via an AF request message including PDU Set related QoS requirements and PDU Set Configuration Information. The AF request can include Nnef_AFsessionWithQoS_Create request for example, as defined in clause 4.15.6.6 of TS 23.502. In some scenarios, the events 810, 812 occur prior to the UE 102 performing 802 the PDU Session Establishment.

Next, the PCF 360 generates the appropriate PCC rules, which may include, or be based on, PDU Set related QoS parameters and PDU Set Configuration Information. The PCF 366 can generate the PCC rules using the information received 812 from the AF 358. The PCF 360 transmits 820 the PCC rules to the SMF 366 via an SM Policy Association Establishment/Modification message (with PCC rules as a parameter).

The SMF 366 performs 830 QoS flow blinding with the SDF. The SDF can be associated with a packet filter set such as IP 5 tuples, and can correspond to an IP flow. The SMF 366 then generates 842 an N4 message with N4 rules based on the PCC rules received from the PCF 360, and transmits 842 the N4 message to the UPF 370.

With continued reference to FIG. 8, the SMF 366 generates 860 the QoS profile(s) based on the PCC rules received from the PCF 360. The SMF 366 further provides 860 the QoS profiles to a node in the RAN 105 via the AMF 364. More particularly, the SMF 366 can transmit, to the AMF 364, a Namf_Communication_N1N2MessageTransfer message including one or more of (i) a PDU Session ID, (ii) N2 SM information (e.g., PDU Session ID, QFI(s), QoS Profile(s)), or (iii) an N1 SM container (NAS message). The NAS message can be a PDU Session Establishment Accept message that includes QoS Rule(s) and associated QoS Flow level QoS parameters. The AMF 364 then can transmit 860 the N2 PDU Session Request message including the NAS message to the RAN 105, for delivery to the UE 102.

The SMF 366 provides 862 the QoS rules to the UE 102 using the remaining steps of the PDU Session Establishment procedure or the PDU Session Modification procedure, depending on the procedure the UE 102 initiated 802 earlier. To configure 862 the UE 102, the RAN 105 can use an RRC Connection Reconfiguration procedure, for example. The RAN 105 can provide configuration parameters based on the information received from SMF 366, to generate the necessary NG-RAN resources related to the QoS Rules for the received PDU Session request. For example, the RAN 105 can provide to the UE 102 SDAP-config settings that include a mapping list of DRBs with allocated list of QoS flows according to a one-DRB-to-many-QoS-flows allocation scheme for uplink communications, downlink communications, or both.

When XRM media traffic is available for transmission to the UE 102, the AS 390 performs 850 an AS operation on the XRM media traffic for delivery over a 5G network, and transmits 852 DL packets to the UPF 370 over the N6 interface.

In response to receiving 852 a DL packet (e.g., a DL PDU), the UPF 370 identifies 870 a PDU Set based on the previously received N4 rules or local configuration at the UPF 370. The UPF 370 marks the GTP-U header of the DL PDU according to the PDU Set based QoS handling in the N4 rule instruction. The UPF 370 transmits 872 the PDU with PDU Set info marked in the GTP-U header to the RAN 105.

Next, the RAN 105 performs 880 PDU Set based QoS handling, maps QoS flow(s) to the DRB(s), and uses the DRB(s) to transmit 882 the DL packets over the NR_Uu interface to the UE 102. To this end, the RAN 105 uses the PDU Set related information in the GTP-U header received over the N3 interface, the QoS profile, and the PDU Set Configuration information received from the SMF 366 over the N2 interface.

The UE 102 receives 882 the DL packets associated with the DRB, maps 884 the DRB to the QoS flow based on SDAP-config received 860 earlier, and forwards the QoS flow to the upper layer application (e.g., the application 142) based on the DL QoS rule the SMF 266 previously configured 860.

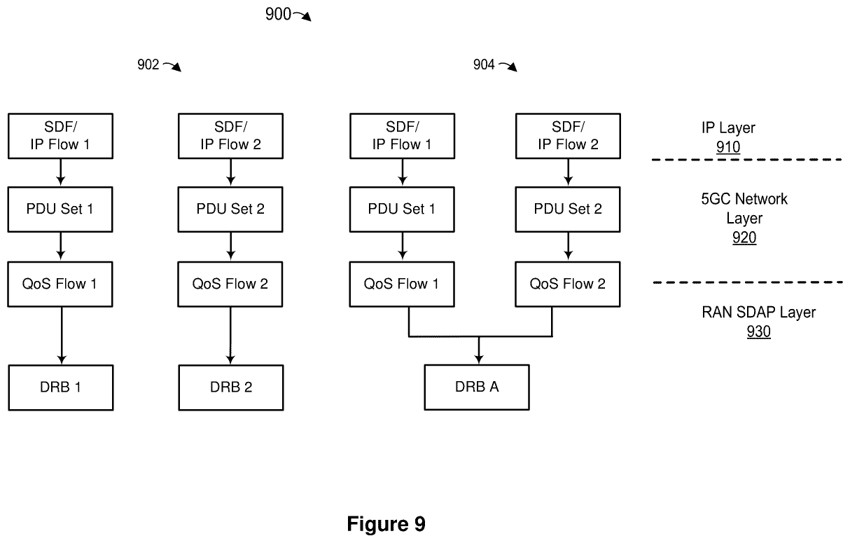

Now referring to FIG. 9, a reference QoS model 900 differs from the reference QoS model 700 of FIG. 7 in the mapping between an SDF (e.g., an IP flow) and PDUs. Unlike the reference QoS model 700, here the application layer uses different IP flows for different PDU Set types (e.g., I/P/B frames or a slice) of a media stream.

More particularly, according to the reference QoS model 900, the AS 390 separates frames or slices, which correspond to different PDU Set types, of the same media type such as video for example, into different IP flows. These IP flows can have the same IP address but different ports, for example.

The AS 390 can generate a request including a PDU Set Configuration, which the RAN 105 can use for PDU-Set-based scheduling (see, e.g., event 810). The request also can include different QoS requirements for different IP flows and aggregated QoS requirements for IP flows that belong to the same media stream. The RAN 105 then can perform PDU Set based scheduling and handling of QoS flows per PDU Set types based on QoS profiles that belong to the same media stream type.

The AF 358 can request QoS requirements (see, e.g., event 812) that include PDU Set based QoS (PS-QoS) parameters for binding of a QoS flow for an SDF/IP flow related to the same media stream, and a QoS Flow Correlation Id. The PS-QoS parameters can include one or more of (i) a PDU Set Delay Budget (PSDB), (ii) a PDU Set Error Rate (PSER), which may be the aggregate of different causes including a PDU Set Dropping Rate (PSDR), (iii) a PSDR, which defines the PDU Sets dropping rate an application expects for a PDU Set type, e.g., I/P/B frame, or PDU Set importance level that binds an SDF to QoS flow(s), (iv) a PDU Set Priority, (v) a PDU Set Periodicity, and (vi) a PDU Set Integrated Indication, which can be an indication of whether the application layer requires all of the PDUs to use a PDU Set. The QoS Flow Correlation Id services to correlate IP flows that belong to the same media stream, and is a parameter that the AS 390 specifies.

The communication system 100 can implement the sequence of high-level procedures or steps discussed below to support traffic using the QoS model 900 (see also FIG. 8). At step A, the AS 390 application server transmits IP flows based on PDU Set types. The PS-QoS requirements apply on per-IP-flow basis. The AF 358 requests different QoS requirements for each IP flow, so that each set of QoS requirements corresponds to one respective IP flow, and each IP flow is associated with one PDU Set type.

At step B, the SMF 366 performs QoS binding from one IP flow to one QoS flow. The SMF 366 further transmits, to the UPF 370, an N4 message including a packet detection rule (PDR) and a QoS enforcement rule (QER). The PDR can include a packet filter which the UPF 370 can use to identify an IP flow of a particular PDU Set type. The QER can include a QoS parameters with an associated QFI.

Next, at step C, the SMF 366 transmits a QoS profile to the RAN 105 over the N2 interface. The QoS profile can include one or more of PS-QoS parameters, a QFI, a QoS Flow Correlation ID, and a PDU Session ID. The SMF 366 can use the QoS Flow Correlation ID to map the QoS flows that belong to the same media stream to one PDU Session ID. In one implementation, if one PDU Session applies to a specific XRM media type, e.g., video, the SMF 366 does not transmit the QoS Flow Correlation ID to the RAN 105.

At step D, the UPF 370 identifies a PDU Set based on a PDU Set PDR (PS-PDR), marks the QFI in the GTP-U header of each PDU, and transmits the PDU to the RAN 105 over the N3 interface.

Finally, at step E, the RAN 105 performs radio resource scheduling based on all QoS profiles with the same QoS Flow Correlation ID. The RAN 105 then maps QoS flows to DRBs per the QFI, i.e., according to a one-to-one mapping scheme. For example, the RAN 105 can perform the mapping from QoS flow 1 to DRB 1 and QoS flow 2 to DRB 2 per the corresponding QFI according to a scenario 902, or perform the mapping from QoS flow 1 and from a QoS flow 2 to DRB A according to a scenario 904.

In another implementation, the PDU Set Configuration includes a PDU Set flow descriptor (e.g., IP 5 tuples) and a PST indication configuration policy, which the AS 390 can use to notify SMF 366 of the PDU Set Types which the application uses for the IP flows of the media stream.

In yet another implementation, the PDU Set Configuration additionally includes a PS-importance configuration policy. The SMF 366 can use the PS-importance configuration policy in the following manner. At step B, the SMF 366 can configure the UPF 370 with a PDU Set marking rule including PS-importance configuration policy, which allows the UPF 370 to determine the PS-importance level based on the upper layer packet header, e.g., depending on the I bit, the D bit, both D bits, or other bits in RTP/SRTP extension header or new extension RTP header or NAL bits. The PS-importance level can further indicate the importance of the PDU within the QoS flow or Sub-QoS flow, which is different from the PDU Set priority included in the PS-QoS parameters. Further, at step C, the SMF 366 can use the PS-importance configuration policy to notify the RAN 105 of the PS-importance levels, e.g., high/medium/low or digitized levels, as marked at the UPF 370.

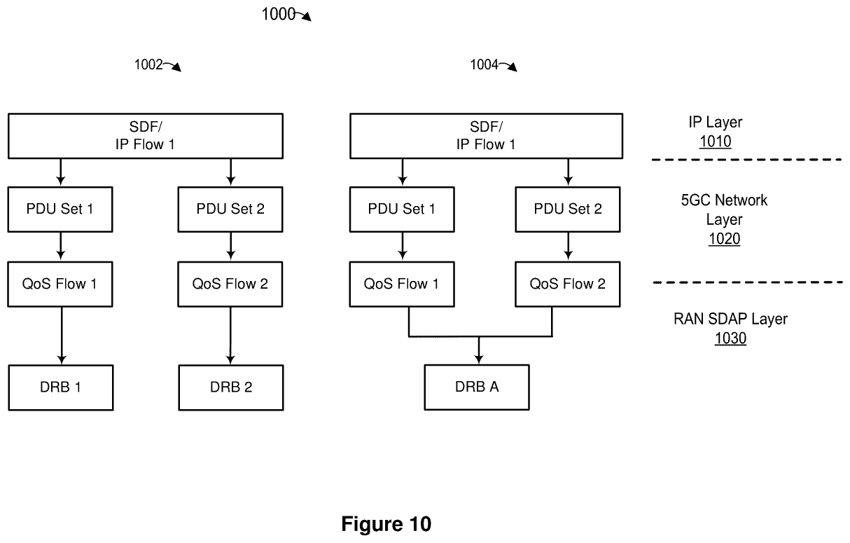

Referring to FIG. 10, a reference QoS model 1000 differs from the reference QoS models 700 and 900 discussed above in that here, the application layer uses the same IP flow for different PDU Set types (e.g., I/P/B frames or slices) of a media stream, and the SMF 366 binds one SDF to multiple QoS flows for different PDU Set types.

More particularly, when using the reference QoS models 100, the AF 358 generates a request that includes a PDU Set Configuration which the SMF 366 can use to configure the UPF 370 for identifying and marking of arriving PDUs, and configure the RAN 105 to handle PDU Set based scheduling. The request also can include QoS requirements within the same IP flow that belongs to the same media stream. The SMF 366 binds one or more SDFs to multiple QoS flows based on PDU Set types and received PDU Set Configuration.

Further, the N2 message which the SMF 366 transmits to the RAN 105 can include a PDU Set based QoS profile. The RAN 105 can perform PDU Set based scheduling for DRBs based on one or more QoS profiles associated with multiple QFIs and PS-QoS parameters.

The AF 358 can request QoS requirements and include, in the request, the following parameters for the same media stream: aggregated (or integrated) QoS parameters for the media stream and/or PS-QoS parameters per PDU Set type or per QoS flow related to the media stream. The aggregated QoS Parameters can include an Aggregated PSDB, an Aggregated PSER, and an Aggregated PDU Set Periodicity, for example. The PS-QoS parameters can include one or more of (i) a PSDB, (ii) a PSER, which may be the aggregate of different causes including the PSDR, (iii) a PDU Set Type Priority, which defines the priority of the PDU Set type for the QoS flow or Sub-QoS flow, a (iv) PSDR, which corresponds to the expected rate at which the drops PDU Sets for a PDU Set type such as I/P/B frame, (v) a PDU Set importance level that binds an SDF a to QoS flow(s), (vi) a PDU Set Periodicity, or (vii) a PDU Set Integrated Indication, which can be an indication of whether the application layer requires all of the PDUs to use a PDU Set.

Further, when using the reference QoS model 1000, the SMF 366 can generate a QoS Flow Correlation ID to correlate the QoS flows that belong to the same media stream.

The communication system 100 can implement the sequence of high-level procedures or steps discussed below to support traffic using the QoS model 1000 (see also FIG. 8). At step A, the AS 390 transmits an IP flow for a media stream, e.g., video. The AS 390 marks each media unit in a (new) dedicated extension RTP header or an N6 tunnel header for encrypted traffic in addition to RTP/SRTP extension header. The AS 390 can mark using a PDU Set Indication, which the UPF 380 uses to differentiate a PDU that requires a PDU Set handling in a 5GC. The AF 358 requests a PDU Set Configuration and QoS requirements for the IP flow of the media stream. To this end, the AF 358 can specify, as a part of the QoS requirements, aggregated QoS parameters for the media stream, and PDU Set based QoS requirements per PDU Set type.

At step B, the SMF 366 performs QoS binding from one IP flow to multiple QoS flows based on the PDU Set Configuration and QoS requirements received from the AF 358. The SMF 366 configures the UPF 370 based on a PDU Set Configuration.

At step C, the SMF 366 generates and uses a QoS Flow Correlation ID to map QoS flows that belong to the same media stream to one PDU Session ID. The SMF 366 then transmits at least one QoS profile to the RAN 105 over the N2 interface. In one such implementation, one QoS profile is associated with a QoS Flow Correlation ID and includes the following: (i) aggregated QoS parameters and the associated QoS Flow correlation ID, (ii) a list of PS-QoS parameters and associated QF, and (iii) a PDU Session ID.

In another implementation, the SMF 366 transmits multiple QoS profiles with different granularities. The QoS profiles can include an aggregated QoS profile per media stream identified by a QoS flow correlation ID, which in turn includes a QoS flow Correlation ID, aggregated QoS parameters, a PDU Session ID, and an optional list of QFIs that associated with the QoS flow correlation ID. The QoS profiles also can include a QoS profile specific to a QoS flow, which includes a QFI, a QoS Flow correlation ID, and PS-QoS parameters.

At step D, when the UPF 370 detects PDUs marked with a PST indication and based on a PS-PDR, the UPF 370 marks the GTP-U header of each PDU with the corresponding QFI, PDU Set information, and importance level based on the PDU Set marking rule, before sending the PDU to the RAN 105 over the N3 interface.

At step E, the RAN 105 performs radio resource scheduling and mapping of the QoS flows to DRBs, based on one or more QoS profiles. The RAN 105 can perform the mapping from QoS flow 1 to DRB 1 and QoS flow 2 to DRB 2 per the corresponding QFI according to a scenario 1002, or perform the mapping from QoS flow 1 and from QoS flow 2 to DRB A per the corresponding QFI according to a scenario 1004.

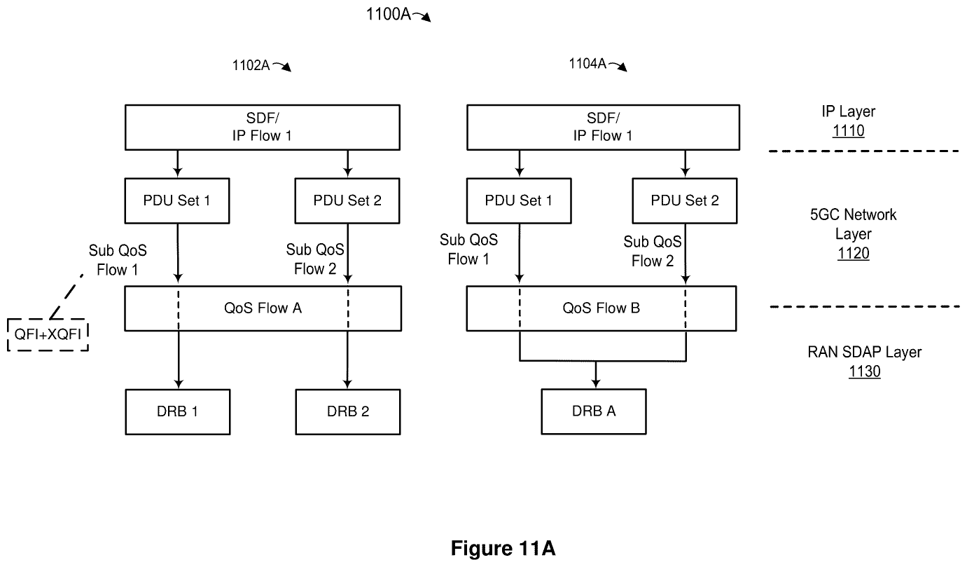

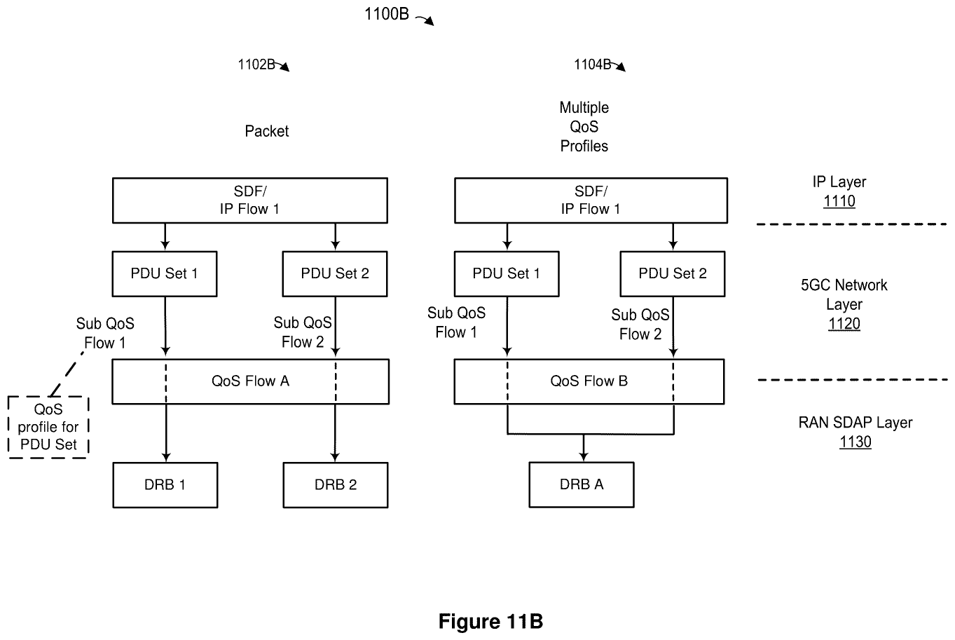

Referring to FIG. 11A, a reference QoS model 1100A differs from the reference QoS models discussed above in that here, the application layer uses the same IP flow for different PDU Set types, (e.g., I/P/B frames or slices) of a media stream, and the SMF 366 binds one SDF to one QoS flow with multiple Sub-QoS flows for different PDU Set types.

Similar to the approach discussed with reference to FIG. 10, the AF 358 generates a request that includes a PDU Set Configuration which the SMF 366 can use to configure the UPF 370 for identifying and marking of arriving PDUs, and configure the RAN 105 to handle PDU Set based scheduling. Also similar to the approach of FIG. 10, the request can include QoS requirements within the same IP flow that belongs to the same media stream. However, here the SMF 366 binds one or more SDFs to multiple Sub-QoS flows based on PDU Set types and the received PDU Set Configuration.

The N2 message which the SMF 366 transmits to the RAN 105 can include a PDU Set based QoS profile. The RAN 105 can perform PDU Set based scheduling for DRBs based on one or more QoS profiles associated with one QFI and multiple Sub-QoS flows (with different XQFIs) and PS-QoS parameters.

The AF 358 can request QoS requirements and include, in the request, the following parameters for the same media stream: aggregated (or integrated) QoS parameters for the service data flow (IP 5 tuples) associated with one QFI, and/or PS-QoS parameters per PDU Set type or per Sub-QoS flow. The aggregated QoS Parameters and the PS-QoS parameters can include elements similar to those discussed above with reference to FIG. 10.

To support traffic using the QoS model 1100A, the communication system 100 can implement a sequence of high-level procedures or steps similar to that discussed above with reference to the QoS model 1000, with the following modifications.

At step B, the SMF 366 performs QoS binding from one IP flow to multiple Sub-QoS flows based on the PDU Set Configuration and QoS requirements received from the 358. The SMF 366 configures the UPF 370 based on the PDU Set Configuration.

At step C, the SMF 366 generates and uses a QFI to map the Sub-QoS flows that belong to the same media stream to one PDU Session ID, and then transmits the QoS profile to the RAN 105 over the N2 interface. In one such implementation, one QoS profile includes the following: (i) aggregated QoS parameters associated with a QFI, (ii) PS-QoS parameters associated with an XQFI, and (iii) a PDU Session ID.

In another implementation, the SMF 366 transmits multiple QoS profiles with different granularities. The QoS profiles can include a QoS profile associated with one QFI, which includes a QFI, Aggregated QoS parameters, a PDU Session ID, and (optionally) a list of XQFIs that are associated with the QFI. The SMF 366 could also transmit a QoS profile on a per-Sub-QoS flow basis, where the QoS profile a QFI, an XQFI, and PS-QoS parameters. The XQFI can identify the Sub-QoS flow.

At step D, when the UPF 370 detects PDUs marked with a PS indication, (optionally) a PST indication, and based on a PS-PDR, the UPF 370 marks the GTP-U header of each PDU with the corresponding QFI+XQFI, PDU Set parameters, and (optionally) PDU Set importance level based on the PDU Set marking rule. The UPF 370 then transmits the PDU to the RAN 105 over the N3 interface.

At step E, the RAN 105 performs radio resource scheduling and mapping of the Sub-QoS flows to DRBs, based on one or more QoS profiles. The RAN 105 can perform the mapping from Sub-QoS flow 1 to DRB 1 and Sub-QoS flow 2 to DRB 2 per the corresponding QFI+XQFI according to a scenario 1102A, or perform the mapping from Sub-QoS flow 1 and from Sub-QoS flow 2 to DRB A per the corresponding QFI according to a scenario 1104A.

According to another approach discussed with reference to FIG. 11B, the UPF 370 identifies each Sub-QoS flow based on the detected packet header information. The communication system 100 can rely on the QoS model 1100B similar to the QoS model 1100A to also support Sub-QoS flows within a QoS flow and provide PDU Set information with different granularities for the RAN 105. However, according to the techniques discussed with reference to FIG. 11A, the SMF 366 defines each Sub-QoS flow during the procedure of binding an SDF with a QoS flow. Each Sub-QoS flow acquires an XQFI during this procedure. According to the technique of FIG. 11B, the UPF 370 identifies each Sub-QoS flow based on the detected packet header information.

More particularly, for the QoS model 1100A, the UPF 370 is configured with a QoS flow corresponding to (identifiable by) a QFI, and Sub-QoS flow information corresponding to XQFI(s). The UPF 370 marks the XQFI in the GTP-U header of the identified PDU based on the PDU Set type in the packet header, and the RAN 105 relies on the QoS profile with the corresponding QFI and XQFI for PDUs scheduling and DRB mapping.

For the QoS model 1100B, the UPF 370 marks additional PDU Set information, including PDU Set Importance Level and/or PDU Set type, in the GTP-U header of the identified PDU, based on the information contained in a higher-layer packet header received over the N6 interface. The RAN 105 relies on the QoS profile corresponding to the QFI and PDU Set QoS parameters for a Sub-QoS flow. The Sub-QoS flow is associated with a PDU Set Importance level and/or PDU Set type for PDUs scheduling and DRB mapping.

In one implementation, the UPF 370 uses PDU Set Identification, which is an RTP/SRTP extension header type, to identify a PDU Set. For each DL PDU received via the N6 interface or the N19 interface, for which a Service Protocol has been determined, the UPF 370 applies the rules for PDU Set identification and determines the PDU Set Information. The UPF 370 provides the PDU Set Information to the RAN 105 in the GTP-U header. The PDU Set Information can include a PDU Set Sequence Number, which is a cyclical counter incremented for each PDU Set instance; an End PDU of the PDU Set, which is a flag that indicates the last PDU of a PDU Set instance; a PDU Sequence Number within a PDU Set, which is a cyclical counter incremented for each PDU within a PDU Set and is reset at PDU Set boundaries; a PDU Set size in byte; and a PDU Set Importance, which identifies the importance of a PDU Set within a QoS flow.

As indicated above, a QoS flow can include multiple Sub-QoS flows. In one implementation consistent with the QoS model 11000B, each Sub-QoS flow is associated with a certain PDU Set type. In other words, each Sub-QoS flow is for PDU Sets with the same PDU Set type. In another implementation, each Sub-QoS flow is associated with a certain PDU Set Importance level, so that a certain Sub-QoS flow is for PDU Sets with the same PDU Set Importance level. In yet another implementation, each Sub-QoS flow is associated with a PDU Set Importance level and a PDU Set type, so that a certain Sub-QoS flow is for PDU Sets that have the same PDU Set Importance level and the same PDU Set type.

Thus, the RAN 105 can identify a Sub-QoS flow based on the PDU Set Importance level, the PDU Set type, or both. The UPF 370 can provide the values in the GTP-U header when transmitting the PDUs over the N3 interface. The UPF 370 detects a PDU and determines to which Sub-QoS flow the PDU belongs using one of the example approaches discussed below.

In one implementation, the UPF 370 uses a local configuration that indicates how the UPF 370 can determine the PDU Set type, the PDU Set Importance level, or both based on the upper-layer packet header. For example, for I/P/B frames, the PDU Set Importance level can depend on the I bit, the D bit, or both D bits, or other bits in RTP/SRTP extension header or new extension RTP header. The PDU Set type can depend on the bits in the RTP/SRTP extension header defined by the PDU Set Configuration Information or a new extension RTP header. For media slices, the PDU Set Importance level or the PDU Set type can depend on specific NAL bits in the existing NAL header or a special-purpose (new) extension NAL header.

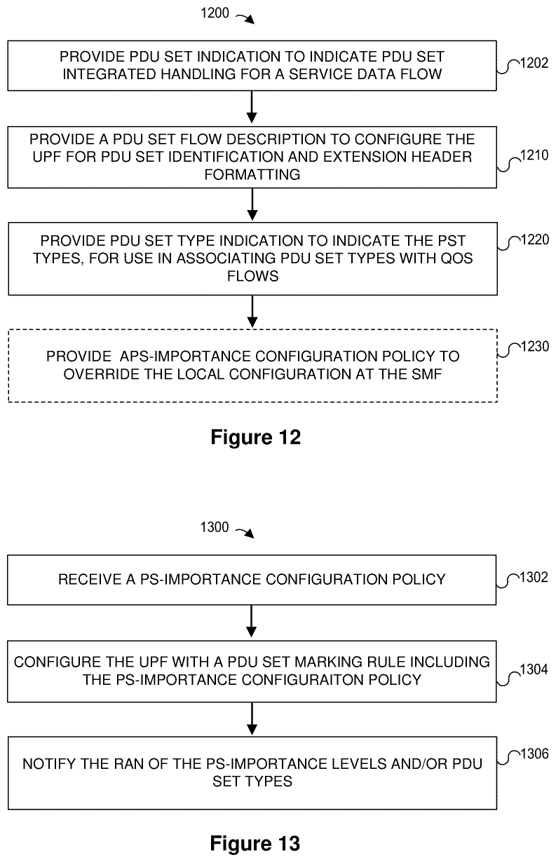

In another implementation, the UPF 370 uses the PDU Set Configuration, which the SMF 366 from SMF as discussed below with reference to FIG. 12. For example, for I/P/B frames, the PDU Set Importance level, the PDU Set type, or both can depend on the PDU Set Configuration which defines specific bits in RTP/SRTP extension header or a special-purpose (new) extension RTP header. For media slices, the PDU Set Importance level, the PDU Set type, or both can depend on the PDU Set Configuration which defines specific NAL bits in the existing NAL header or a special-purpose (new) extension NAL header.

Referring to FIGS. 11A and 11B, the AF 358 can generate a request that includes a PDU Set Configuration, which the SMF 366 can use to configure the UPF 370 for identifying and marking an arriving PDU in the GTP-U header, which the UPF 370 then transmits to the RAN 105 for handling PDU Set based scheduling. The request from the AF 358 can include QoS requirements that apply within the same IP flow that belongs to the same media stream. The SMF 366 binds one or more SDFs to one QoS flow containing multiple Sub-QoS flows. The UPF 370 can detect and identify each Sub-QoS flow based on the XQFI allocated by SMF (in accordance with the QoS model 1100A), or the PDU Set type detected by the UPF 370 (in accordance with the QoS model 1100B, the PDU set type option), or the PDU Set Importance level detected by the UPF 370 (in accordance with the QoS model 1100B, the PDU Set Configuration from the SMF 366 option), or the PDU Set Importance level along with the PDU Set type detected by the UPF 370 (in accordance with the QoS model 1100B, the PDU Set Importance level and the PDU Set type option).

Further regarding the models of FIGS. 11A and 11B, the N2 message travelling from the CN 110 to the RAN 105 can include a PDU Set based QoS profile that contains PDU Set QoS Parameters per Sub-QoS flow, where the RAN 105 can identify the Sub-SoS flow by the XQFI (in accordance with the QoS model 1100A), the PDU Set type (in accordance with the QoS model 1100B, the local configuration option), the PDU Set Importance level (in accordance with the QoS model 1100B, the PDU Set Configuration from the SMF 366 option), or the PDU Set Importance level and PDU Set type (in accordance with the QoS model 1100B, the PDU Set Importance level and the PDU Set type option).

The RAN 105 performs PDU Set based scheduling for DRBs based on the PDU Set based QoS profile received from the SMF 366 and the GTP-U headers of PDUs received from the UPF 370 over the N3 interface.

The AF 358 can request QoS requirements that includes parameters for an SDF (e.g., IP 5 tuples) of the media stream. The SDF corresponds to a QFI which the SMF 366 allocates after QoS being. The aggregated (or integrated) QoS parameters can include one or more of (i) an aggregated PSDB, (ii) an aggregated PSER, or (iii) an aggregated PDU Set Periodicity. The PS-QoS parameters per Sub-QoS flow can include (i) a PSDB, (ii) a PSER, which can correspond to an aggregate of causes including the PSDR, (iii) a PDU Set Periodicity, (iv) a PSDR, or (v) a PDU Set Integrated Indication.

When the QoS requirements contain both Aggregated/Integrated QoS parameters and PS-QoS parameters per Sub-QoS flow, the SMF 366 can configure the PDU Set based QoS profile (for sending to the RAN 105) with aggregated QoS parameters and PS-QoS parameters per Sub-QoS flow.

When the QoS requirements contain only Aggregated/Integrated QoS parameters, based on the information of the PDU Set Configuration, the PCF 370 and/or the SMF 366 can determine the referenced PS-QoS parameters for each Sub-QoS flow corresponding to (i) XQFI (in accordance with the QoS model 1100A), or the PDU Set type (in accordance with the QoS model 1100B, the PDU set type option), the PDU Set Importance level (in accordance with the QoS model 1100B, the PDU Set Importance level option), or the PDU Set Importance level and PDU Set type (in accordance with the QoS model 1100B, the PDU Set Importance level and the PDU Set type option). When the QoS requirements contain only Aggregated/Integrated QoS parameters, the SMF 366 can configure the PDU Set based QoS profile (for sending to the RAN 105) with aggregated QoS parameters and referenced PS-QoS parameters per Sub-QoS flow.

When the QoS requirements contain only PS-QoS parameters per Sub-QoS flow, based on the information in the PDU Set Configuration, the PCF 366 and/or the SMF 366 can determine Aggregated (or Integrated) QoS parameters such as the aggregated PSDB, the aggregated PSER, or the aggregated PDU Set Periodicity. In this case, the SMF 366 configures the PDU Set based QoS profile using aggregated QoS parameters and PS-QoS parameters specified on per Sub-QoS flow basis.

Thus, with continued reference to FIG. 11B, one QoS Flow can include multiple Sub-QoS flows. At least the following three options are available for characterizing each of the Sub-QoS flows. According to the PDU Set type option, each Sub-QoS flow is for PDU Sets with the same PDU Set type. For example, Sub-QoS flow 1 is for I-frames and Sub-QoS flow 2 is for B-frames. According to the PDU Set Importance level option, each Sub-QoS flow is for PDU Sets with the same PDU Set Importance level. For example, Sub-QoS flow 1 is for PDU Set with Importance level 1 and Sub-QoS flow 2 is for PDU Set Importance level 2. According to the PDU Set Importance level and PDU Set type option, each Sub-QoS flow is for PDU Sets associated to the same PDU Set Importance level and PDU Set type. For example, Sub-QoS flow 1 is for I-frames with PDU Set Importance level 1, and Sub-QoS flow 2 is for I-frames with PDU Set Importance level 2.

To support traffic using the QoS model 1100B, the communication system 100 can implement a sequence of high-level procedures or steps similar to that discussed above with reference to the QoS model 1110A, with the following modifications.

At step B, the SMF 366 performs QoS binding from one IP flow to one QoS flow and configures the UPF 370 based on the PDU Set Configuration and the QoS requirements received from the AF 358. A QoS flow can include multiple Sub-QoS flows according to at least the following options, which the UPF 370 can implement: (i) according to the PDU Set type option, each Sub-QoS flow is for PDU Sets with the same PDU Set type, (ii) according to the PDU Set Importance level option, each Sub-QoS flow is for PDU Sets with the same PDU Set Importance level, and (iii) according to the PDU Set Importance level and PDU Set type option, each Sub-QoS flow is for PDU Sets associated with the same PDU Set Importance level and PDU Set type, as discussed above.

At step C, the SMF 366 generates and uses a QFI to map a service data flow of the media stream to one PDU Session ID, determines QoS parameters, and transmits the QoS profile including QoS parameters to the RAN 105 over the N2 interface. The SMF 366 can provide the QoS profile to the RAN 105 according to at least the following two options: according to the scenario 1102B, a QFI identifies one QoS profile identified by QFI, and the QoS profile includes a PDU Session ID, a QFI, aggregated QoS parameters, and PS-QoS parameters on a per Sub-QoS flow basis (according to one of the PDU Set type option, the PDU Set Importance level option, or the PDU Set Importance level and PDU Set type option discussed above; according to the scenario 1104B, one QoS flow is associated with multiple QoS profiles, a QoS profile corresponds to a QFI, and the QoS profile includes the QFI, aggregated QoS parameters, and a PDU Session ID. Further, according to the latter option, a Sub-QoS profile on a per Sub-QoS flow basis can be based on one of the PDU Set type option, the PDU Set Importance level option, or the PDU Set Importance level and PDU Set type option. The Sub-QoS profile can include a correlated QFI, a PDU Set type and/or PDU Set Importance Level, and PS-QoS parameters.

At step D, when the UPF 370 detects a PDU marked with a PS indication, marked with an (optional) PST indication, and based on a PS-PDR and a PDU Set marking rule, the UPF 370 marks the GTP-U header of the PDU with the QFI and the PDU Set information. The PDU Set information can include a PDU Set Importance Level and/or PDU Set type according to one of the PDU Set type option, the PDU Set Importance level option, or the PDU Set Importance level and PDU Set type option, in addition to the PDU Set Sequence Number, End PDU of the PDU Set, the PDU Sequence Number within the PDU Set, and PDU Set Size in bytes. The UPF 370 then transmits the PDU with the GTP-U header to the RAN 105.

At step E, based on one QoS profile or multiple QoS profiles, the RAN 105 performs radio resource scheduling and maps the QoS flows based on QoS profile(s) to DRBs. According to the scenario 1102B, the RAN 105 performs the mapping based on one QoS profile, e.g., for one QoS flow to DRB per a QFI and PDU Set Importance Level and/or PDU Set type, according to one of the PDU Set type option, the PDU Set Importance level option, or the PDU Set Importance level and PDU Set type option discussed above. According to the scenario 1104B, the RAN 105 performs the mapping based on multiple QoS profiles so that, for example, Sub-QoS flow 1 maps to DRB A and Sub-QoS flow 2 maps to DRB A based on the correlated QFI and PDU Set Importance Level and/or PDU Set type (again according to one of the PDU Set type option, the PDU Set Importance level option, or the PDU Set Importance level and PDU Set type option). As a more particular example consistent with the scenario 1104B, Sub-QoS flow 1 maps to DRB A and Sub-QoS flow 2 maps to DRB A based on QFI and PDU Set Importance level, as a form of one-to-one mapping. In some cases, different QFIs (bound to different SDFs) with similar QoS parameters and the same PDU Set Importance level map map to the same DRB.

Next, an example technique for generating PDU set configuration is discussed with reference to FIG. 12. A method 1200 can be implemented in the AS 390 and/or the AF 358, for example. For convenience, this method is discussed with reference to the application layer.

At block 1202, the application layer generates a PDU Set Indication to indicate, to the SMF 366, that the SMF 366 should apply PDU Set Integrated Handling for the service data flow. At block 1210, the application layer generates a PDU Set flow description to indicate an RTP/SRTP extension header type the UPF 370 should use for PDU Set Identification at UPF. At block 1220, the application generates a PDU Set Type Indication (PST indication) to indicate the PST types used by the application for the media streams. The SMF 366 and/or the UPF 370 use the PDT indication to differentiate PDU Set types and associate these types with different respective QoS flows, when the application applies a specific PST indication configuration policy (e.g., when the application uses a specific upper layer packet header). When the AF 358 does not specify the PST indication, the SMF 366 and the UPF 370 use reconfiguration settings, bases on standard values, or based on the RTP/SRTP extension header or the NAL header.

In some implementations, the method 1200 further includes an optional block 1230, where the application layer further includes a PS-importance configuration policy in the PDU Set configuration. When included in the PDU Set configuration, this parameter takes precedence over local configuration at the SMF 366. The SMF 366 can use the PS-importance configuration policy to configure the UPF 370 with a PDU Set marking rule including a PS-importance configuration policy, which allows the UPF 370 to determine the PS-importance level based on the upper-layer packet header, e.g., depending on I-bit, D-bit, or both D bits, or other bits in RTP/SRTP extension header or new extension RTP header or the NAL bits.

More particularly, referring to FIG. 13, a method 1300 can be implemented in the SMF 366 for example to process a PS-importance configuration policy. At block 1302, the SMF 366 receives the PS-importance configuration policy from the AF 358 or the AS 390 for example. At block 1304, the SMF 366 can use the PS-importance configuration policy to configure the UPF 370 with a PDU Set marking rule including a PS-importance configuration policy.

In one scenario or implementation, for the QoS flow or Sub-QoS flow binding, the SMF 366 applies the PS-importance level to associate PDU Sets with the same or different PDU Set importance levels, to associate PDU Sets based on PDU Set types, or to associate PDU Sets based on both of PDU Set Importance level and PDU Set type. In another scenario or implementation, for an inter-PDU Set of a QoS flow or Sub-QoS flow, the SMF 366 indicates the PS-importance level and/or PDU Set type for each PDU Set of a QoS flow or Sub-QoS flow, which is different from the PDU Set Type priority included in the PS-QoS parameters. In another scenario or implementation, for an intra-PDU Set, the PS-importance level and/or PDU Set type can indicate the importance level and/or PDU Set type of each PDU within the PDU Set.

At block 1306, the SMF 366 notifies the RAN 105 of the PS-importance levels (e.g., high, medium, or low, or a suitable set of discrete levels) as well as of the PDU Set types (e.g., I/P/B frames or slices) marked by the UPF 370. The PS-importance levels take precedence over the local configuration at the RAN 105.

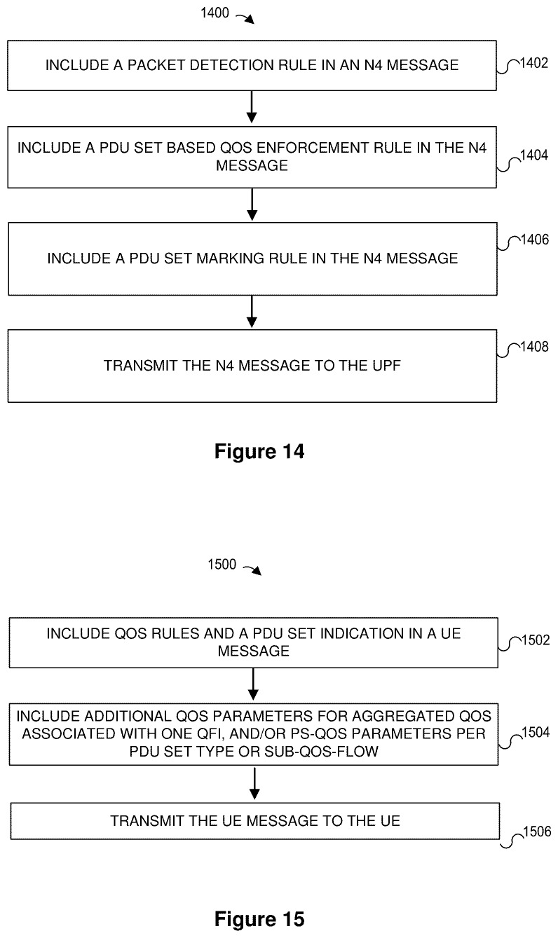

Now referring to FIG. 14, the SMF 366 also can implement an example method 1400 to generate an N4 message to the UPF 370 for PDU Set handling, for transmission over the N4 interface. The SMF 366 can execute the method 1400 at step B of the scenarios discussed above with reference to the QoS models.

At block 1402, the SMF 366 includes a PDR in the N4 message. The PDR can include a packet filter which the UPF 370 uses to identify a PDU Set based on a PDU Set Configuration that includes a PDU Set Type Indication (when the QoS model 1000 or 1100A applies) and RTP/SRTP extension header or the Network abstraction layer header (when the QoS model 1000,1100A, or 1100B applies).

At block 1404, the SMF 366 includes a QER in the N4 message. The QER provides PDU Set based QoS parameters with the associated QFI (when the QoS model 1000 applies), or provides PDU Set based QoS information with associated QFI+XQFI (when the QoS model 1100A applies), or provides a set of PDU Set based QoS parameters with an associated QFI for Sub-QoS flows based on the PDU Set Importance Levels and/or PDU Set types (when the QoS model 1100B applies).

At block 1406, the SMF 366 includes, in the N4 message, a PDU Set marking rule that provides information related to the QFI, the PDU Set information, and the PS-importance configuration policy based on the PDU Set Configuration (when the QoS model 1000 applies), or provides information related to the QFI+XQFI, the PDU Set parameters based on the PDU Set Configuration (when the QoS model 1100A applies), or provides information for marking a GTP-U header, including the QFI, the PDU Set information, and the PS-importance configuration policy based on the PDU Set Configuration (when the QoS model 1100B applies).

At block 1404, the SMF 366 transmits the N4 message to the UPF 370.

FIG. 15 is a messaging diagram of an example method 1500 which the SMF 366 can implement to provide QoS rules to the UE 102 during the PDU Session Establishment or Modification procedure, for example. The SMF 366 can modify or augment the existing QoS flow descriptions as discussed below, so that the UE 102 can handle PDU Set based QoS flows.

At block 1502, the SMF 366 can include a PDU Set Indication in the UE message. The SMF 366 can provide the PDU Set Indication along with the QoS rules include a QoS Rule Identifier (QRI), the length of the QoS rule, a rule operation code, a a default QoS rule (DQR) bit, the number of packet filers, a packet filter list, a packet filter precedence, and QFI. The SMF 366 also can provide, in the same or a separate message, QoS flow descriptions that include a QFI, and operation code (create, modify, delete), QoS parameters (5QI, GFBR/MFBR uplink/downlink, avg. window, EPS bearer ID), etc.

Next, at block 1504, the SMF 366 can include additional QoS parameters for the PDU Set including, for an aggregated (or integrated) QoS associated with one QFI, one or more of (i) a PDFB, (ii) a PSER, or (iii) an aggregated PDU Set Periodicity.

For PS-QoS parameters per PDU Set type or Sub-QoS flow of a QoS flow (corresponding to a certain QFI), in which the Sub-QoS flow can be identified based on XQFI (per QoS model 1100A), PDU Set Importance level (per QoS model 1100B), or PDU Set type (per QoS model 1100B), the SMF 266 can include, in the UE message, one or more of (i) a PSDB, (ii) a PSER, which may be the aggregate of different causes including a PSDR, (iii) a PDU Set Type Priority, which defines the priority of the PDU Set type for the QoS flow or Sub-QoS flow, (iv) a PSDR, (v) a PDU Set Periodicity, or (vi) a PDU Set Integrated Indication.

At block 1506, the SMF 366 transmits the UE message to the UE 102.

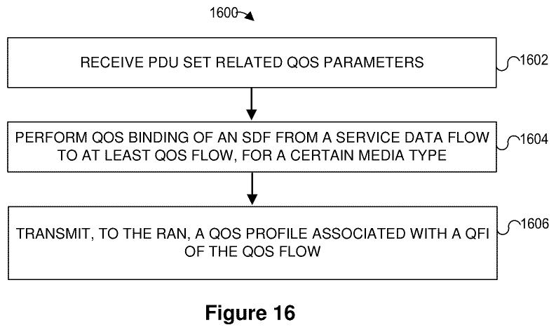

Finally, FIG. 16 is a messaging diagram of an example method 1600 which the SMF 366 can implement to support QoS flows for a media type. At block 1602, the SMF can receive PDU Set related QoS Parameters (see, e.g., event 820). At block 1604, the SMF can perform QoS bending of the SDF from one SDF (or IP flow) to one QoS flow, per media type (see, e.g., event 840). At block 1606, the SMF can transmit the QoS to the RAN (see, e.g., event 860).

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a core network (CN) of a wireless communication system, the method comprising:
receiving quality-of-service (QoS) parameters related to protocol data unit (PDU) Set based handling of traffic;
performing, using the QoS parameters, a QoS binding of a service data flow (SDF) to at least one QoS flow for a certain media type;
generating a QoS profile associated with a QoS flow identifier (QFI) of the QoS flow for the media type; and
transmitting the QoS profile to a radio access network (RAN) via which the UE accesses the CN.

2. The method of claim 1, wherein the receiving of the QoS parameters includes receiving policy and charging control (PCC).

3. The method of claim 2, wherein the PCC rules include a PDU Set configuration.

4. The method of any of the preceding claims, wherein the performing of the QoS flow binding includes:
binding the SDF to multiple QoS flows for different respective PDU Set types.

5. The method of any of claims 1-3, wherein the performing of the QoS flow binding includes:
binding the SDF one QoS flow with multiple Sub-QoS flows for different respective PDU Set types.

6. The method of claim 5, further comprising:
defining the multiple Sub-QoS flows during the binding; and
allocating a respective sub-QoS flow ID (XQFI) each of the multiple Sub-QoS flows.

7. The method of claim 5 or 6, wherein the different PDU Set types correspond to types of frames of a video stream.

8. The method of any of the preceding claims, further comprising:
configuring a user plane function (UPF) with a PDU Set marking rule.

9. The method of claim 8, wherein the configuring includes:
configuring the UPF with a PS-importance configuration policy for determining a PS-important level based on an upper-layer packet header.

10. The method of claim 9, further comprising:
transmitting the PS-importance configuration policy to the RAN.

11. The method of any of the preceding claims, wherein:
the SDF includes only traffic of the certain media type.

12. The method of claim 11, wherein the media type is one of voice, video, or extended reality (XR).

13. The method of any of the preceding claims, wherein:
the QoS profile is further associated with one or more QoS parameters for the certain media type.

14. The method of any of the preceding claims, wherein the SDF is an Internet Protocol (IP) flow.

15. A device comprising processing hardware and configured to implement a method according to any of the preceding claims.
